(19) United States
(12) Patent Application Publication
(10) Pub. No.: US 2010/0011495 A1
(43) Pub. Date: Jan. 21, 2010

(54) VENTILATION THROUGH SERVICE FLAP FRAMES

(75) Inventors: Reinhard Neubauer, Wurzburg (DE); Frank Wunderlich, Netphen (DE)

Correspondence Address: PEARNE & GORDON LLP, 1801 EAST 9TH STREET, SUITE 1200, CLEVELAND, OH, 44114-3108, US

(73) Assignee: DOMETIC GMBH, Siegen (DE)

(21) Appl. No.: 12/526,799

(22) PCT Filed: Feb. 22, 2008
(86) PCT No.: PCT/EP08/01446

§ 371 Date: Sep. 30, 2009

(30) Foreign Application Priority Data
Feb. 22, 2007 (DE) 10 2007 008 792.8

(51) Int. Cl. E03D 9/04; B60J 5/00

(52) U.S. Cl. 4/347; 296/146.1

(57) ABSTRACT

The invention relates to a flap unit (1) for fitting into a flap opening, which allows access to a luggage or service compartment, in the wall of a camping vehicle. Said unit comprises a flap frame (3) and a flap (2) that is pivotally mounted on said frame and the flap frame preferably consists of a first frame part (5), which borders the flap opening on the vehicle interior and a second frame part (6), which borders the flap opening on the vehicle exterior, in such a way that the first and second frame part (5, 6) interlock when mounted. One frame part (6) has a connection (11) for coupling a ventilation or water supply or drainage line on the vehicle interior and said connection (11) can be linked to the external surroundings of the vehicle in such a way that the line coupled to the connection comes into contact with said surroundings through at least said frame part (6).

The invention concerns a flap unit to be installed in a flap section in the wall of a camping vehicle according to the generic part of claim 1 as well as a water tank system or toilet system comprising a corresponding flap unit to be installed in a camping vehicle according to claim 13, including a corresponding application.

It is to be stated at this stage that in the following the term camping vehicle (provided not otherwise declared) is used in its broad sense and comprises caravans as well as motor homes.

Unlike modern car chassis, the construction of camping vehicles is, without exception, not (completely) self-supporting. Rather is the construction of camping vehicles erected on a support frame; in the case of camping trailers it is a chassis comprising metal sections, in the case of motor homes, as a rule, it is the rear underfloor frame section and possibly the driver's cabin of the motor vehicle, serving as a base. The external walls of the camping vehicles (side, top and bottom) typically have a sandwich construction; the outer layer, as a rule, is formed by a thin aluminium sheet or a thin, usually fibre reinforced, plastic skin. The inner layer, as a rule, is configured as a thin timber panel or thin plastic panel. As a rule, a frame support (mostly timber) and an insulation is situated between them. Lately partly strong self-supporting wall panels are also used, for example in the form of two sheet metal, timber or plastic layers, which are firmly joined with a honeycomb core or the like situated between them.

In a camping vehicle there is the requirement to provide flaps in many positions, to make storage or service compartments (accommodating tanks, gas bottles or the like) externally accessible. Apart from the flap openings, as a rule, in the walls of camping vehicles a number of further openings or cut-outs are also provided, perhaps for the purpose of ventilation or drainage.

The general problem is that the walls of a camping vehicle during travel deform relative one another to a greater or lesser extent, since the undercarriage cannot offer a 100 percent torsional rigidity (even when one deals with original truck undercarriages). In addition, there are not only stresses between the individual parts of the wall, but the walls also act in the region of the cut-uts for flaps, ventilation and drainage. On the other hand the above mentioned sandwich materials, usually used to construct the wall, are not very resistant to pressure. Therefore frames, that provide the edging of openings in the walls, cannot be particularly firmly pressed onto the external wall surface. For this reason it is not simple to reliably seal openings in the walls of camping vehicles past the nominal service life of such vehicles (which, as a rule, is more than 150,000 km, whereas 100,000 km in the case of motor homes often mark the end of the 3-year guarantee).

To enable to deal with the sealing problem in wall openings as well as possible, for quite a while frames have been used, like for example that known from the German utility model 200 19 933 U1. These frames usually comprise a first frame section that is pushed into the wall section from the inside, and a second frame section that is pushed into the wall section from the outside. The two frame sections meet (in most cases approximately at the centre of the opening), then are pressed against one another and are fastened on one another in this position, usually by locking with one another. In this manner the frame is braced against the wall, so that by virtue of the elastomer sealing placed between them or the adhesive and/or putty a water-tight joint is produced between the external frame section and the outside of the wall. Such frame constructions have proved themselves almost for all openings, irrespective whether one deals with large openings for flaps or smaller openings for ventilation apertures.

Despite this careful sealing each opening in the wall of the vehicle increases the risk of leakages occurring with the passing of time and that the penetration of water into the vehicle in this region, finally destroying it.

That had already been recognised in the state-of-the-art. EP 0 679 771 B1 suggests to provide a service flap, i.e. the door leaf of which can be pivoted to the open and closed position, with an opening, through which a ventilating hose blasts to the outside even when the flap is closed. Although such a solution can do without an additional opening in the wall of the vehicle outside of the region determined by the service flap, it presents other problems. In this case there is namely the risk that the service flap as such is tight all around, i.e. along its edges, but due to the additional opening in the flap itself water will penetrate. In addition, the hose, attached to the flap, impedes the pivotability of the flap, requires additional room behind the closed flap and is at a risk to bend or develop fatigue and break or tear off during the repeated pivoting to the open and closed positions.

Therefore the object of the invention is to reduce the total number of wall openings required in a vehicle for various purposes.

This objective is achieved with a flap unit, wherein at least one frame section has a connection on the inside of the vehicle for coupling a ventilation or water supply or drainage pipe, while this connection can be connected with the surroundings outside of the vehicle that the pipe, attached inside, is connected with the surroundings outside of the vehicle through at least this one frame section.

In this manner at least one additional opening in the vehicle can be saved, that would otherwise be necessary to run the said pipes or their endings to the exterior through the wall of the vehicle. This reduces the manufacturing expenses required for the construction and reduces the risk of leaks.

The invention is ideal to run pipes with a relatively small diameter to the exterior, for example those which prevent the build-up of excessive pressures by the sewage gas occurring in a faecal tank at summer temperatures, or pipes which during the filling of the fresh water tank (in particular with pressurised water from the general water supply) let the air escape from the tank and in particular in the case when the filling limiter technically fails to let the excess pressurised water overflow from the tank before it bursts or becomes excessively deformed.

The invention can, however, at least as a second thought, alternatively or additionally, sensibly used for letting a pipe for the supply of fresh water to open to the exterior, so that it can be operated from the outside. The region of the opening of such a pipe is, of course, closed by a suitable device so that to prevent contamination from the outside and/or loss of water due to surges caused by the travelling.

Particularly ideal and therefore the foremost application of the invention is for service flaps to close a service compartment of a toilet unit. After all, modern toilet units have, without exception, a faecal tank, that for the purpose of discharge has to be pulled out from the outside through a service flap. In a sensible manner for such a tank a ventilation pipe, guided to the outside through the wall, has to be provided if the build-up of sewage gas is to be totally prevented by adding chemicals. This is also the case when a pressure equalisation is to be provided for that case when the camping vehicle (as it is often the case) is used on mountainous stretches. In that case in the absence of a tank ventilation marked pressure differential occurs in a large capacity tank, and when the toilet is first used unpleasant gases would penetrate into the wet area. As one can easily imagine this takes place when, for example, one commences with the camping vehicle on flat surface in the vicinity of sea level and the trip ends in the evening on a camping site in a mountain valley or one has to use the toilet during a break on a mountain pass.

According to an advantageous development the port of the connection, opening into the external surroundings of the vehicle, is protected by a cover from surging water or the entry of foreign objects from the outside. At the same time this cover is so designed, that surging water or possible foreign objects cannot penetrate from the outside of the port in a straight movement perpendicularly to the plane of the opening. Such a cover is particularly sensible in conjunction with open openings from used air or drainage pipes. This prevents that, for example, water or dirt, sprayed by the tyres of other vehicles picked up would penetrate deep of the connection in a straight path and with a corresponding momentum into the interior through the opening of the connection and would then block the opening. The latter is important especially concerning dirt, as it is not sure that dirt, that could be accelerated with momentum through the opening of the connection, would run off again on its own through the opening of the connection and without obstructing the connection. This is, however, also valid for water that in most cases carries dirt particles.

According to a further advantageous development the port is set back relative a section of the external frame section situated above it in the direction of the interior of the vehicle. In this manner the external frame section forms a balcony-like (in the widest sense) projection over the port. This will prevent that large amount of the water, running down on the wall of the vehicle, would enter into the port. This because the large portion of the water running down on the wall of the vehicle will drip downwards from the bottom edge of the section of the frame section situated above the port and not inward around this frame section, in the direction of the port. Due to the surface tension this could be done only by some drops.

Another development provides that the port is arranged in the region of the external frame section, that is situated outside of the region bordered by the seal between the flap and the external frame section, yet is still covered by the flap. In this manner the port of the connection can be particularly simply protected directly against the ingress of rushing water or dirt without the necessity of a separate cover.

Another development of the invention provides that the connection is separated from the region of the inside flap opening and its projection into the interior of the vehicle by, as a rule, approximately horizontal wall protruding into the interior of the vehicle. The decisive consideration here is that a damage to the connection by pieces of bulky luggage or luggage moving back and forth has to be prevented. Damage caused by a bulky luggage can occur, for example, when the user attempts to pull it (in practice often a stove, for example) out from the usually tightly packed luggage compartment and the luggage gets caught with one of its edges on the inside of the wall, namely exactly where the connection is situated. Since all components discussed here are, as a rule, made from plastic material, in this case there is a risk of damage. This is especially the case at low temperatures, when the plastic material, in certain cases, is brittle (winter camping). Similar problems threaten when during travel a piece of luggage moves back and forth in the partly empty luggage compartment and in the region of the connection hits the wall from the inside or slides along the wall in this region, for example during hard breaking. In all these cases a wall section of the kind claimed here is of help, namely a wall section that is so designed that a bulky piece of luggage does not get caught inside on the connection, but prior to reaching the connection on said wall section that protects the connection.

The connection ideally terminates on the inside of the vehicle in a pouch or a pouch-like region of the frame section that is essentially open only in the direction of the interior of the vehicle. This means nothing else just that the connection terminates in a depression of the frame section that surrounds it like a collar and thus protects it from getting damaged from all sides.

The connection is preferably configured as a tubular socket, that is so long and has such a wall thickness or wall section that a hose can be pushed and secured on it. At the same time the tubular socket has preferably a circular or, in some cases, also an oval cross-section. However, in other cases the cross-section can be that of a polygon tube, e.g. an octagon. This is namely when the hose to be pushed on has sufficient elasticity.

Provided the hose is not to be fastened by using a hose clamp that, as it is known, has to exert a corresponding clamping effect to be effective, care should be taken that the tubular socket has an appropriate wall thickness, depending on the material from which it is made. Alternatively or in addition to a hose fastening, a barbed fork-like fastening may be used, i.e. corresponding ribs on the outside contour of the tubular socket, which make it possible to push an elastic hose on but have a certain resistance against pulling it off because in the direction of pulling off they “bore” into the elastic material of the hose.

Another essential development of the invention provides that the tubular socket has an integrally formed plug, that seals its opening watertight against the exterior of the vehicle. At the same time this “plug” is so constructed and arranged, that it can be removed to use the socket as intended. It could be conceived, of course, to close such a socket with a separate, for example rubber-elastic plug. Such a plug, however, may get lost. In addition, it represents an additional component, that has to be separately produced and then installed. Therefore it is beneficial to provide the tubular socket, that is usually integrally manufactured by injection moulding together with the corresponding frame section, with an also integrally moulded plug. This can be, for example, in the form of a thin, ideally diaphragm-like wall from that plastic material, from which the frame and the socket are made. Such a diaphragm-like wall has the advantage that it can be opened by simply piercing it through using a pointy tool, what is of particular advantage when in the case of an installed flap frame the socket is to be used when retrofitting work is being carried out.

The sealing described makes a universal application of the flap units according to the invention feasible, i.e. also for such vehicles in which no ventilation, draining or the like should be carried out through the flap unit. Due to the moulded-on sealing such flap units reliably retain their sealing capacity.

Ideally the plug is configured in the form of a wall that, for example, extends relative the socket in the radial direction and thus blocks the free cross-section of the socket. At the same time the wall is provided in that end region of the socket which points toward the hose to be attached, and finally the socket is made so long that the end region of the socket, carrying the said wall, can be removed. Depending on an actual case or accessibility to the socket, this can be carried out by sawing off the socket, or, considerably better, by cutting the socket off, for example, with a head cutter or the like. Due to the length of the socket the function will not be impaired when the socket is shortened in this manner, i.e. the hose can be reliably pushed on the remaining length of the socket.

An application of the invention concerns a water tank system to be installed in a camping vehicle, with a water tank that can be installed in the vehicle, a connection to fill or flush the water tank from the outside (through the wall of the vehicle) as well as a flap unit, while the water tank has an overflow that ventilates and/or drains overflowing water via the connection provided in the flap unit to connect a used air-drainage pipe.

It is nowadays the standard, that water tank systems in camping vehicles are not filled by conveying the water through the interior, the living area, but from the outside. This requires a further cut-out through the lateral wall. A swift filling of this water tank using a water hose, that is inserted into the filler opening or is even attached to it in an airtight manner, necessitates the removal of the air displaced from the water tank by the rising liquid level. In the simplest case the water tank is provided for this purpose with an opening to the living area. This has, however, the disadvantage that moisture may exit into the living area when the water sloshes back and forth during travel. It would be even more precarious when the tank is to be filled with pressurised water. If the person filling the tank forgets to turn off the supply of the pressurised water in time, considerable amount of water would enter from the ventilation openings into the living area.

It is the task of the invention to provide a remedy in this case. That is achieved by that the tank ventilates and/or drains the overflowing water to the exterior via the connection provided in the flap unit for the connection of a used or air-drainage pipe. The flap unit ideally has a second connection that is attached from the inside to the supply pipe to the water tank and makes the filling of the water tank from the outside possible. In this manner even two, otherwise additionally necessary openings in the wall can be omitted, namely an additional ventilation opening and an additional filler opening.

When using the water tank system according to the invention for a tank, that also supplies the kitchen and/or sink of a camping vehicle with potable water, the system is particularly accepted by users when the overflow connection and the filler connection for the potable water tank are integrated in a flap unit that is different from the flap unit that encloses the service compartment with the sewage tank of the toilet. Therefore it stands to reason to make a normal storage compartment unit a component of the water tank system according to the invention, provided one deals with a tank for potable water. This can be accomplished without any problem also because luggage compartments and additional luggage compartments are in many cases arranged in the region of seats or beds, below which the potable water tank and/or the boiler are also provided. Therefore in an ideal case two water tank systems according to the invention are used for a well equipped vehicle, namely one, the components of which include the flap unit enclosing the service compartment for the sewage tank, and another one, concerning the potable water tank and the components of which include the flap unit enclosing the luggage compartment or a gas bottle compartment.

The preferred embodiment of the invention provides that the connection is so constructed that a filler hose, conveying the pressurised water, can be tightly attached to it, so that the supply pipe for the water tank in the interior of the vehicle can be charged with pressurised water and in this manner the tank can be filled also from a level which is below the lowest level in the tank. In this case ideally a valve, responding in accordance with the water level, is provided in the water tank, preferably in the form of a float valve. This valve interrupts the supply connection between the connection and the water tank against the water pressure, as soon as a predetermined water level is reached in the water tank. In this manner it will be ensured that the tank will not be overfilled or pressurised by the water supply and overloaded or even burst. The ventilation and draining pipe from the tank via the flap unit to the exterior plays an important role also in this case, as if the valve, responding to the water level, fails, a reliable draining is still present in this manner.

Further advantages and possible configurations of the invention can be recognised based on the embodiments described in the following. They show in:

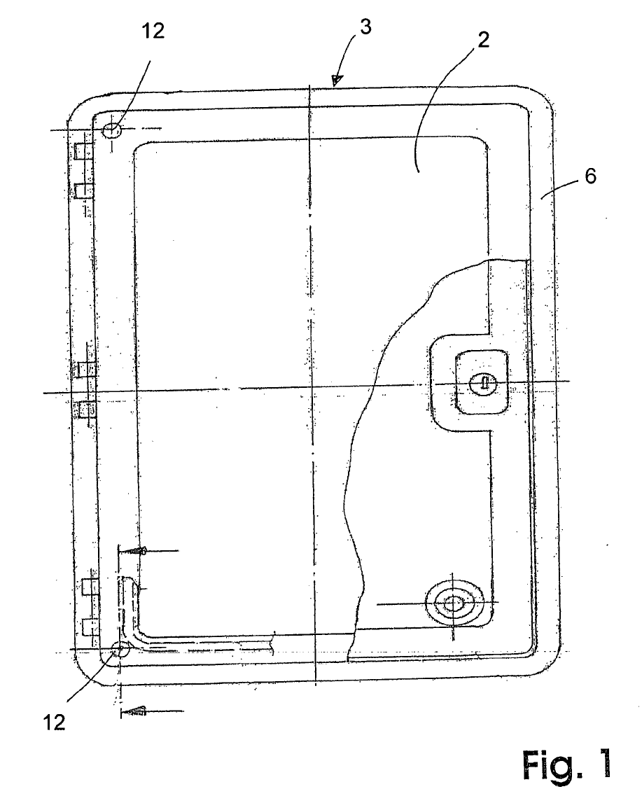

FIG. 1—a flap unit according to the invention with the flap closed, so installed in the wall of a camping vehicle that the flap opens to the left,

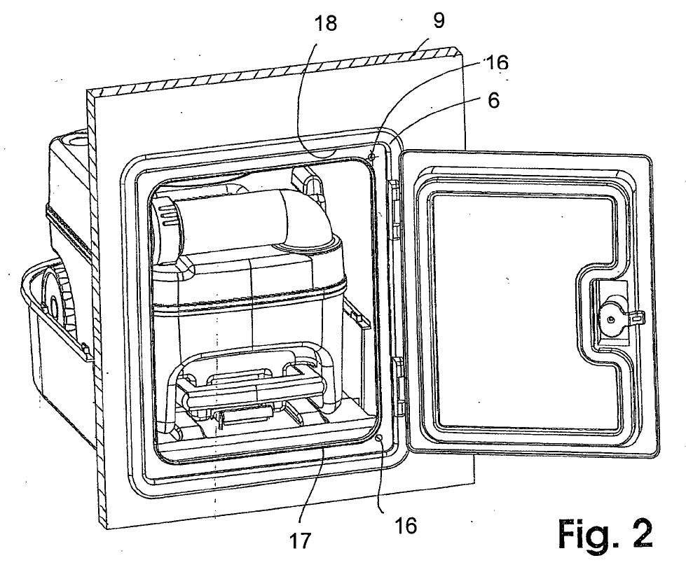

FIG. 2—the flap unit already illustrated in FIG. 1, but to be able to be opened to the right the flap is installed rotated at 1800 and illustrated in perspective, partly sectioned,

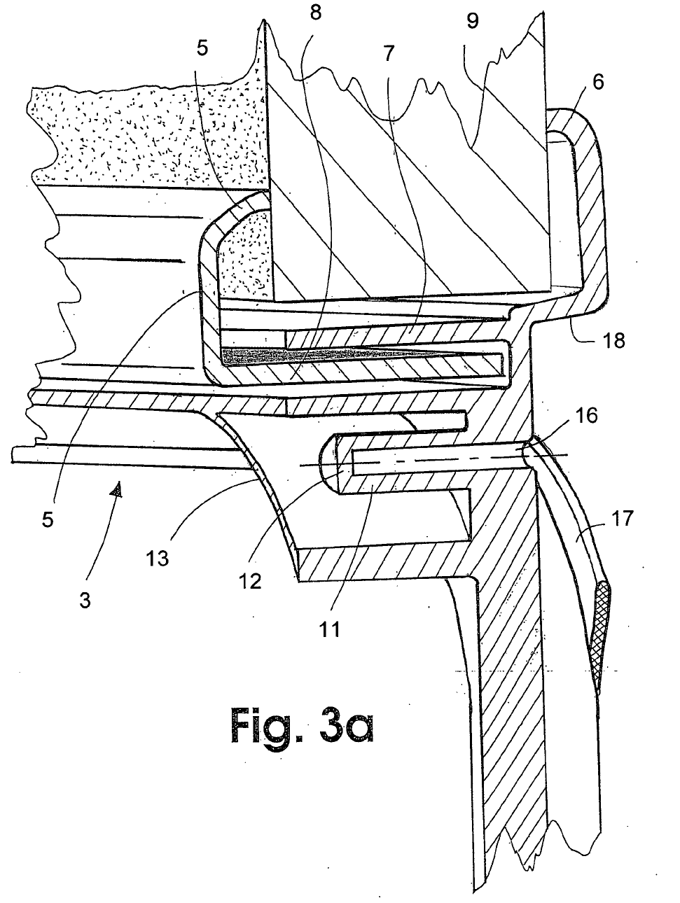

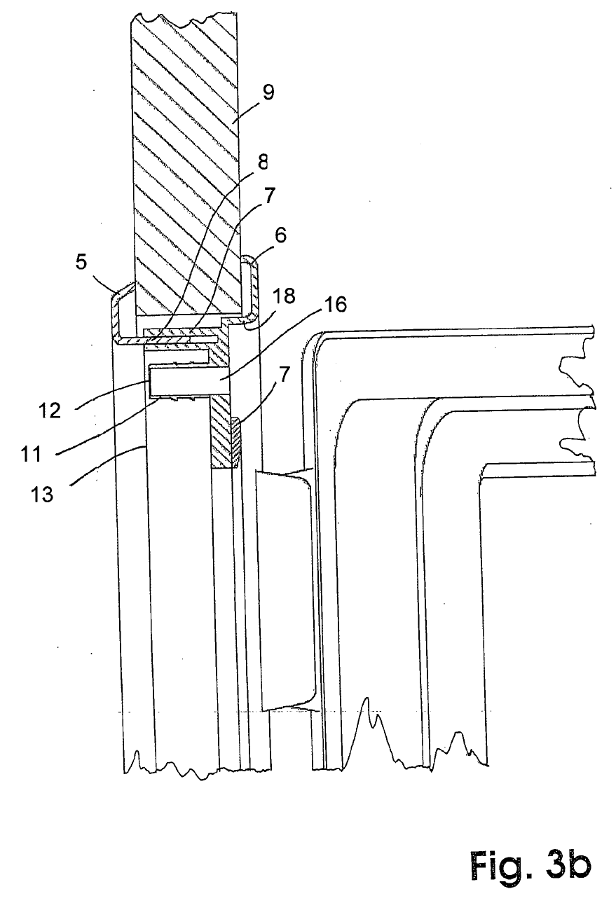

FIG. 3a—the (left) top corner of the flap frame of the installed flap unit according to FIG. 1, viewed from behind in perspective and partly sectioned, i.e. from the interior of the vehicle,

FIG. 3b—the (right) top corner of the flap frame of the installed flap unit according to FIG. 2, in partial longitudinal section, viewed from the side,

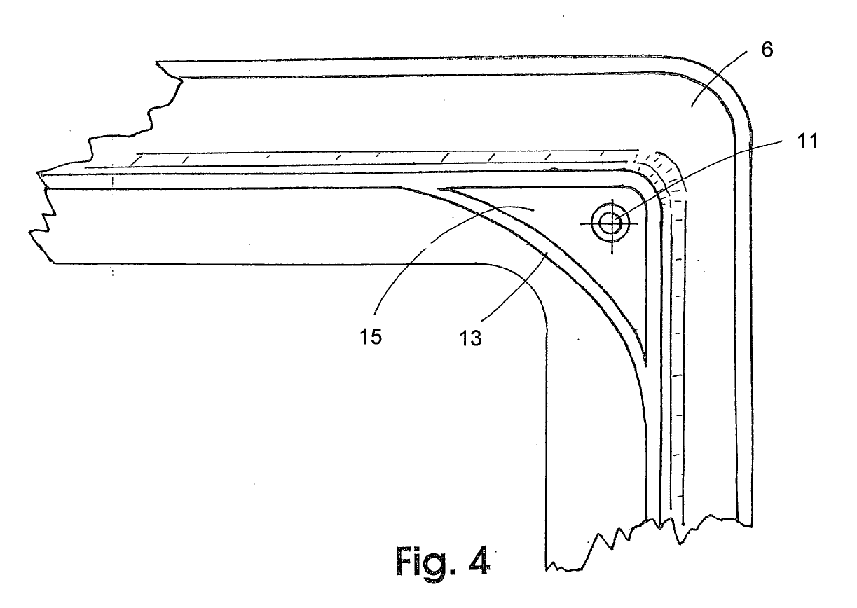

FIG. 4—the (left) top corner of the external frame section of the flap frame illustrated in FIG. 2, in a non-installed state and from that side which subsequently faces the interior of the vehicle,

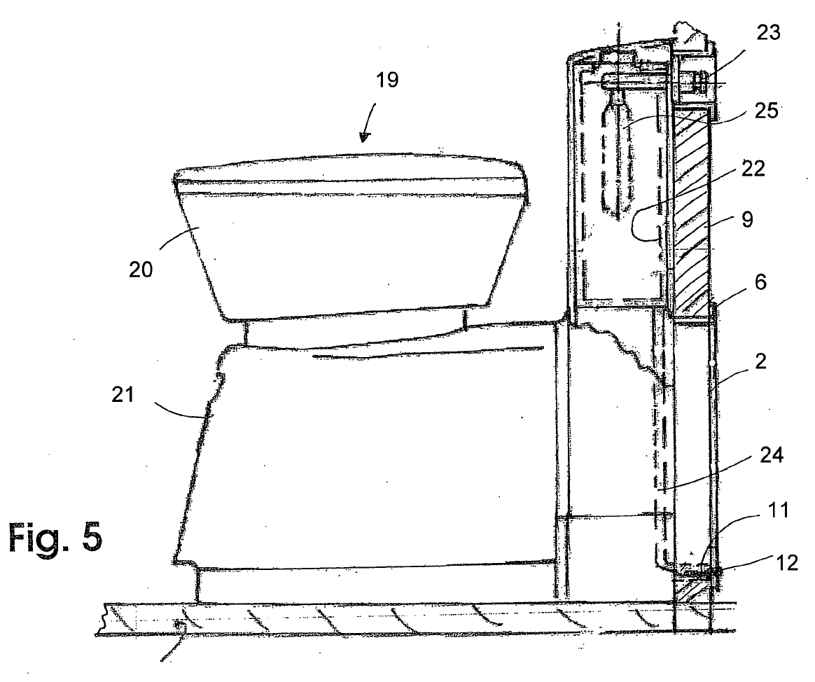

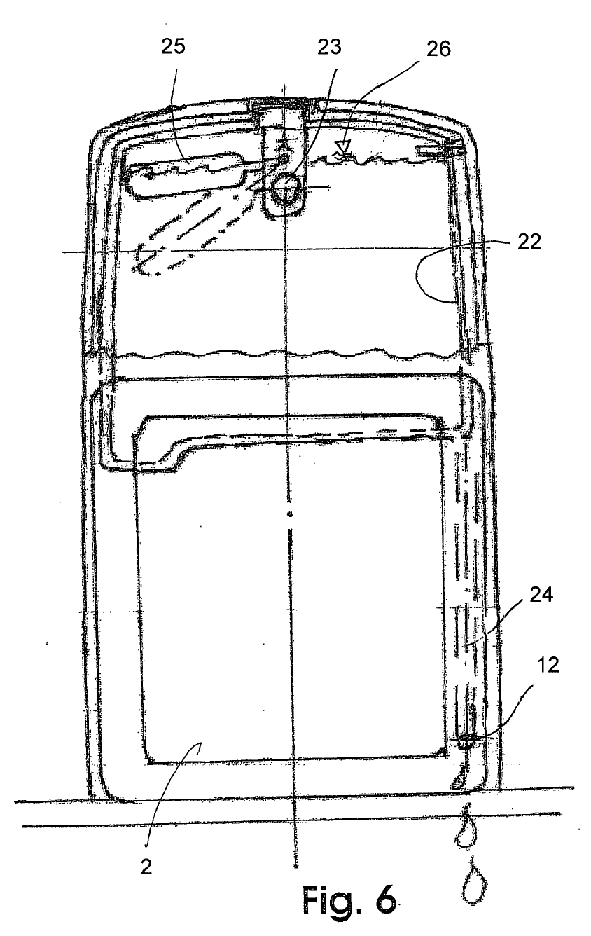

FIGS. 5 and 6—an application for the flap unit according to the invention in conjunction with the ventilation of a flushing water tank supplied by pressurised water,

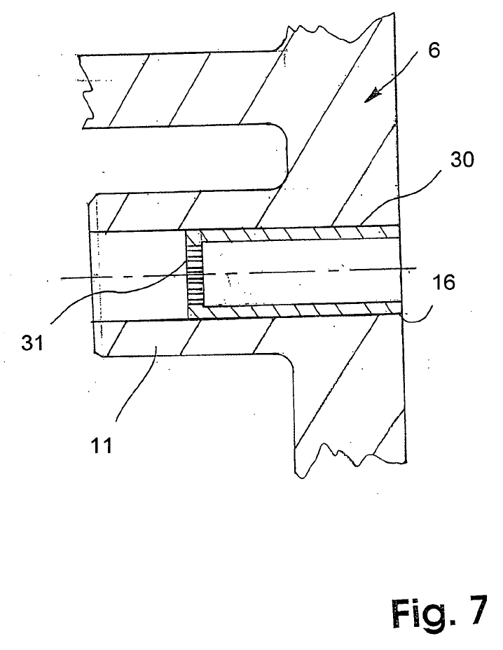

FIG. 7—an embodiment of the securing of the connection 11 against the penetration of insects.

FIG. 2 shows the flap unit 1 according to the invention in the form of a so called service flap 2 (FIG. 1), that is pivotably hinged on the associated flap frame 3 and closes off a service compartment, in which a sewage tank 4 is accommodated. For the purpose of discharging and cleaning, the sewage tank 4 can be pulled out through the service flap opening and removed from the vehicle. In the stowed position the sewage tank can be connected via an appropriate valve (not illustrated here) to the toilet bowl that, as a rule, is provided above it, so that the flushing from the toilet bowl can be into the tank 4.

The exact configuration of the flap frame 3 is shown in FIG. 3 [sic]. The flap frame 3 comprises a first frame section 5, that provides the edging of the cut-out for the flap in the wall of the vehicle from the inside, and a second frame section 6, that provides the edging of the cut-out for the flap in the wall of the vehicle on the outside. Both frame sections 5, 6 are formed, as a rule, as frame structures closed in the circumferential direction and are usually made of high quality plastic material that obtains its sophisticated shape by injection moulding. The first frame section 5 is inserted from the interior of the vehicle into the prefabricated cut-out of the flap in the wall, the second frame section 6 from the outside. One of the frame sections (in this case the second) has, as a rule, a continuous groove structure 7, into which the other frame section is inserted with its correspondingly shaped, as a rule continuous collar 8 in the course of the assembly of the frame sections 5, 6. In this manner the two frame sections 5, 6 form a flap frame 3, that on the outside appears as a unit. In most cases one of the frame sections 5, 6 (in the region of its groove structure or its collar) is provided, for example, with garbed fork or locking-type holding means (not illustrated here), that act in such a manner that when the two frame sections are pressed against one another lets the collar 8 penetrate into the groove structure 7 but it cannot slip out in the reverse direction.

In this manner both frame sections 5, 6 can be particularly effectively and reliably joined with one another, by both frame sections being pressed against the respective surface of the wall 9 of the vehicle. A bolting together of the two frame sections 5, 6 is also possible, even when this is not the preferred means; the frame sections 5, 6 can be braced against one another by means of bolts. This is particularly the case when the frame sections 5, 6 are not bolted against the wall 9 that does not provide much support for the bolts, but with passing-through bolts against one another.

To join the frame sections 5, 6 with one another in the manner described above, a reliable sealing is ensured between the second, external frame section 6, and the external surface of the wall 9. This pre-manufactured elastic seal (not illustrated here), between the second frame section 6 and the wall 9, can be recognised for instance in the chamber 10 in FIG. 3 [sic] between the second frame section 6 and the wall 9 of the vehicle. Instead of that a permanently elastic sealing and/or adhesive compound can be provided between the second frame section 6 and the wall 9 of the vehicle, that by virtue of the second frame section 6 being pressed against the wall 9 in the wet state is evenly pressed and will so set that an all around seal is produced. A flap frame 3, fastened in the cut-out of the wall in this manner, overcomes even stronger distortions of the wall 9 of the vehicle supporting it, without relative movements between the wall 9 and the flap frame 3 causing problems in the seal. This is particularly true when the flap frame 3 is made from plastic material and consequently due to its elasticity “follows” the wall 9 even in the case of robust distortions.

Such a construction of the flap frame 3 has not only the advantage that in this manner a reliable sealing is produced. At the same time such a flap frame 3 also offers the advantage to “telescopic” to some extent, perpendicularly to the wall surfaces. By virtue of this the tolerances of the wall thickness can be well compensated for. In the case of an appropriate configuration even one single flap frame 3 may be used for wall thicknesses that have originally different dimensions.

Due to the above preferably flap frames of the above described kind are used to carry out the invention, as despite light walls they sustainably support the aim of the invention, namely to achieve a possibly reliably sealed vehicle construction.

As FIG. 3 [sic] well illustrates, in the region of the top corner the external frame section 6 has a connection 11 for the purpose of fastening an aeration or ventilation and drainage pipe coming from the interior of the vehicle. In this case the connection is configured as a tubular socket having an essentially circular cross-section. The socket is integrally moulded with the external frame section, however, in an emergency it could be an extra part (inconvenient) adhered to or welded into an opening of the external frame section. FIG. 3 [sic] shows the socket in the state without a pipe being attached to it. As it can be seen, the channel provided inside of the socket is a blind hole. Instead of that at that end of the socket which faces the inside of the vehicle it is closed off by a moulded wall, that functions as a plug 12. Provided the socket is not used, it is in this manner reliably sealed without any additional effort. This makes it feasible to provide on one flap unit a plurality of such connections, e.g. in two different corners. Depending on whether the flap unit is installed opening to the left, or rotated by 180° to the right, under certain circumstances only one of the two connections 11 is activated, the other remains closed without any problem. The same applies when, for example, four connections are provided, of which, for example, only two are activated.

It can also be seen from FIG. 3 [sic], that the connection formed in this case as a tubular type, is protected by a wall section 13 with a great radius laterally from the region of the inner flap opening 14. Due to this the tubular connection, that in the region of its merging into the actual frame section 6 is exposed to a considerable notch effect, is protected; differently from baggage storage flaps, in this actual embodiment this is only of secondary importance, since in this case due to the appropriately guided tank there is practically no risk that when the tank is being pulled out it gets inadvertently caught on the connection and damages it. The other way around, the wall section 13 protects also the user from surprising injuries, for example by a metallic hose clamp for fastening a hose on the socket, “lurking” behind the corner of the frame.

FIG. 4 shows that the tubular socket is protected not only by the wall section 13, but it is also accommodated in a pouch-like depression 15, that at the same time serves in the region of the corner of the frame also to reinforce its strength.

The comparison of FIGS. 2 and 3 [sic] shows that the port 16 of the connection 11, terminating in the exterior, is situated in a region that in the case of a closed flap 2 is covered by same. In this manner the port is protected from the direct entry of surging water and dirt. Nevertheless, the port has an essentially unhindered connection to the exterior, since the port is situated outside of the region of the rear of the flap sealed by the seal of the flap. Therefore it is in connection with the exterior almost unhindered via the considerable, as a rule, gap between the flap 2 and the flap frame 3 (with its rear the flap 2 lies against the flap seal 14[sic] at a certain distance from the flap frame 3, and along its circumference it has in any case a considerable clearance to the flap frame 3, otherwise the flap would jam even during deformations usually caused when parking the vehicle on uneven terrain).

FIG. 3 [sic] shows that the port 16 is arranged in the region of the depression of the flap frame 3 that accommodates the flap 2; FIG. 3 [sic] illustrates as to how the (top) port 16 is set back relative the flange of the frame section 6 situated above it, so that the corresponding portion of the frame section 6 forms relative the port 16 a “balcony-like” overhang 18. Namely an overhang 18, that essentially lets the water running towards the wall to drip downwards and thus keeps it away from the port 16.

As has already been mentioned, the connection 11 made available by the flap system according to the invention is used in particular to connect an aerating and ventilating pipe for a sewage tank with the exterior without the need of providing an additional cut-out in the wall of the vehicle. Such an aerating and ventilating pipe requires only a relatively small cross-section to the exterior for the port (as a rule between 4-16 mm). Therefore the connection 11, necessary for such a pipe, can be easily accommodated in the mostly rounded corners of the flap frame, without perceivably reducing the inside cross-section of the flap opening or increasing the flap frame.

Depending on the individual case, care should be taken to secure the connection 11 against the penetration of bugs all kind. For this purpose the connection is sensibly fitted with a screen having small apertures, that blocks its inside cross-section against bugs (e.g. ants). This is especially of importance when the connection 11 is used for the aeration and ventilation of a faecal tank, as there are all sorts of bugs which are attracted by the tank's evaporation, especially when the user of the tank, to protect the environment, uses less chemicals. This blocking is particularly simple and effective when using a corresponding protective insert 30 in the form of a sleeve (made, as a rule, from plastic material), into which a gauze or a firm plastic wall 31 with fine, screen-like openings is integrated, or something similar. This sleeve is pushed into the connection 11 either from the side of the port 16 (or from the opposite side), while it is so constructed that it locks in or locks by friction after being pushed in. Alternatively, it is pushed on and locked in from the outside on the correspondingly constructed connection. It would be often sensible, when the gauze/the “screen” 31 would not be directly tightened over the port 16, but would be further towards the inside of the vehicle, so that not to be obstructed by dirt, that under unfavourable circumstances would reach up to the region of the port 16. This is illustrated in FIG. 7.

Alternatively, a coarse cylindrical filter mat (preferably with irregular fibre structure, as it is usual in the car industry) made rigid by adding bonding agents and having a construction similar to that of a cigarette filter is pushed into the connection 11, said filter mat remaining in place in the connection 11 (not illustrated here) on its own possibly by virtue of its elasticity and compressibility without any aid by appropriate supporting rings.

As a further option, that is not illustrated in the drawings, the connection may be provided with a valve, that (for a short period) opens only when a certain pressure differential is present through the connection 11 (or through its valve).

Another application for the flap system according to the invention are shown by FIGS. 5 and 6; in particular FIG. 5. One deals here with a toilet system 19. Essentially it comprises a base 21 supporting the toilet bowl 20, the base at the same time forming a storage space for the sewage tank 4 and being accessible from the outside through the flap unit 1 according to the invention.

Above the region of the sewage tank 4, as a rule (also in this case) a tank 22 for the flushing water is provided. This tank 22 for the flushing water is a conventional enclosed plastic tank, that holds the water stored in it during travel. The tank 22 for the flushing water has a connection 23 for the pressurised water. To this connection a pipe, that is connected to the general water supply of a camping site, can be attached by an appropriate screw- or rapid coupling, and the tank 22 is filled or topped up through this pipe. The size of the tank 22 may vary; it can be (provided it has a large enough capacity) the single tank to supply the toilet system with flushing water. Instead of this in addition to another water tank for the supply of water during travel may be provided, namely as additional water tank for the comfortable operation of the camping vehicle, to be described later in detail (mostly during prolonged stationary operations).

Since the tank 22 for the flushing water, differently from household flushing systems, is enclosed, an aeration and ventilation pipe 24 is provided. This leads from the tank 22 for the flushing water to the flap unit 1 according to the invention, that encloses the service compartment for the tank 4 for the flushing water [sic]. The aeration and ventilation pipe is attached to the connection 11 of the flap system according to the invention and via it is connected to the exterior. Provided the tank does not have an equalising opening to the wet area, the aeration and ventilation pipe 24 prevents during flushing the formation of vacuum in the tank 22 caused by the outflowing flushing water. When filling the tank 22 with pressurised water it makes the evacuation of the air, displaced from the tank 22, possible.

The overflow function of this pipe 24 is even more important. When the tank 22 is likely to be overfilled, because the water flow for whatever reason is not interrupted in time, this pipe 24 prevents the formation of an undue pressure in the tank 22 or even an overflow from the tank 22 to the wet area.

This is particularly important to enable to accomplish the following comfort condition: on that side where the pressurised water supply is connected, the tank is fitted with a valve 25, operating depending on the water level in the tank; the valve in this case is a conventional float valve. It closes off the supply of pressurised water as soon as a certain level 26 is reached in the tank. In this manner it is possible to leave the connection 23 for the supply of pressurised water permanently during the holiday period (or during this long-term camping) spent at one spot to the pipeline of the pressurised water at the camping site. In this manner the tank 22 for the flushing water will fill up automatically. If, within the scope of the embodiment described, the tank 22 is provided above the flushing level of the toilet bowl, the necessity of an electrically operated pump for flushing water becomes redundant. This is a particularly great advantage when flushing during the night. This is because the conventional, 12 V electrical immersion pumps emit a penetrating, howling noise that due to its mounting in the resonant body, “the tank”, is well and truly amplified, in any case when the tank is not full.

However, the accomplishment of this comfort condition relies on the overflow function, that ideally (even if not inevitably) is to be realised according to the invention. It happens namely, repeatedly, that valves, opening and closing depending on the level, do malfunction. For a mobile holiday home the failure of such a valve in the case of a permanent connection to the pressurised water supply means “finish”, at least when the mishap is not noticed very early. Namely, as soon as the capacity of the toilet bowl is exhausted the water overflows the wet area and after a short while flows into the living area. Once a considerable amount of water penetrates into the living area and the supporting, in most cases timber structure of a camping vehicle, as a rule the vehicle cannot be saved; a wet living area of such vehicles can hardly dried at a reasonable expense and definitely not during the holiday. Apart from this the structure swells in a very short time and consequently becomes unusable.

The tank 22 for the flushing water is ideally provided in addition to a regular water tank and serves its purpose only during stationary phases when pressurised water is permanently available. In this case the tank 22 for the flushing water can be arranged relatively high in the vehicle. It has namely a small tank capacity. It does not influence the centre of gravity of the vehicle even when it is filled during travel. The water tank of the vehicle, to be filled in the known manner for the mobile operation, has a markedly greater capacity. Therefore it is normally provided as low as possible on the vehicle.

For a further increase of the comfort (increase of the flushing effect or surge flushing also during mobile operation) an electric pumping equipment may be provided, that can be optionally switched on to replenish the tank 22 for the flushing water from the main water tank after flushing.

The “replenishment solution with overflow” can, of course, be used not only for the tank for the flushing water in camping vehicles, but also for the fresh water tank (main tank) of the vehicle, thus to automatically “replenish” the fresh water storage of the entire vehicle for the duration of the stationary stay, while the distribution of the fresh water in the vehicle is carried out in the usual manner by electric immersion pumps or the like provided for this purpose.

### LIST OF REFERENCE NUMERALS

1 Flap unit
2 Flap
3 Flap frame
4 Tank
5 First frame section (as a rule on the inside)
6 Second frame section (as a rule on the outside)
7 Continuous groove structure
8 Continuous collar
9 Wall of the vehicle
10 Chamber
11 Connection
12 Plug
13 Wall section
14 Inside flap opening
15 Pouch-like depression
16 Port
17 Flap seal
18 “Balcony-like” overhang
19 Toilet system
20 Toilet bowl
21 Base
22 Tank for flushing water
23 Connection for pressurised water supply
24 Aeration and ventilation pipe
25 Level valve
26 Water level
30 Protective insert to prevent the ingress of insects
31 Screen of the protective insert

1. A flap unit (1) to be installed in an access to a flap opening in the wall of a camping vehicle serving as a luggage or service compartment with a flap frame (3) and a flap (2) pivotably mounted on it, while the flap frame comprises preferably a first frame section (5) forming an edge of the flap opening on the inside of the vehicle, and a second frame section (6) forming an edge of the flap opening on the outside, in such a manner that in the installed state the first and the second frame section (5, 6) engage one another, characterised in that a frame section (6) has a connection (11) on the inside of the vehicle for coupling a ventilation or water supply or drainage pipe, while this connection (11) can be so connected with the surroundings outside of the vehicle that the pipe, connected to it, is connected with the surroundings outside of the vehicle through at least this one frame section (6).

2. A flap unit (1) according to claim 1, characterised in that the port (16) of the connection (11), opening into the external surroundings of the vehicle, is protected by a cover (2) from surging water or the entry of foreign objects from the outside, this cover is so designed, that surging water or foreign objects cannot penetrate from the outside of the port (16) in a straight movement perpendicularly to the plane of the opening.

3. A flap unit (1) according to claim 1 or 2, characterised in that the port (16) is set back in the direction of the interior of the vehicle relative a section [sic] (18) of the external frame section (6) situated above it.

4. A flap unit (1) according to claim 2 or 3, characterised in that the port (16) is arranged in the region of the external frame section (6), that is situated outside of the region bordered by the seal (17) between the flap and the external frame section, yet is still covered by the flap (2).

5. A flap unit (1) according to claim 4, characterised in that the port is situated in the region of the top edge of the flap (2) and so far above the seal (17) between the flap and the external frame section (6), that surging water surge running down along the seal does not flood into the port (16).

6. A flap unit (1) according to any one of the preceding claims, characterised in that the connection is separated from the region of the inside flap opening (14) and its projection into the interior of the vehicle by a wall section (13).

7. A flap unit (1) according to claim 6, characterised in that the connection terminates on the inside of the vehicle in a pouch-like depression (15) of a frame section that is essentially open only in the direction of the interior of the vehicle.

8. A flap unit according to any one of the preceding claims, characterised in that the connection (11) is a tubular socket, that is so long and has such a wall thickness or wall section that a hose can be pushed and secured on it, preferably by means of a hose clamp.

9. A flap unit according to claim 8, characterised in that the tubular socket has an integrally formed plug (12), that seals it watertight against the exterior of the vehicle, while the plug (12) is so constructed and arranged, that it can be removed to use the socket as intended.

10. A flap unit according to claim 8, characterised in that the plug (12) is constructed in the form of a wall that blocks the free cross-section of the socket and is so dimensioned that it can be pierced through with a pointy object to commence the operation of the socket.

11. A flap unit according to claim 9 or 10, characterised in that the plug (12) is configured in the form of a wall that blocks the free cross-section of the socket and is provided in that end region of the socket which points toward the hose to be attached, while the socket is made so long that the end region of the socket, carrying the said wall, can be removed, preferably by cutting off with a side-cutter or the like without impairing the function of the socket.

12. A flap unit according to any one of the preceding claims, characterised in that the connection (11) is secured against the penetration of bugs by a mesh, a filter, a screen (31), a valve or the like.

13. The application of the flap unit according to any one of the preceding claims to enclose a service compartment allocated to a toilet (19), in which the sewage tank allocated to the toilet (19) is accommodated in a removable manner, characterised in that a connection (11) of the flap unit (1) is used to connect an aeration and/or ventilation pipe of the sewage tank with the exterior and possibly a further connection (11) of the flap unit (1) is used to make the filling of a water tank that supplies the toilet, feasible.

14. A water tank system to be installed in a camping vehicle, with a water tank (22) that can be installed in the vehicle, a connection (23) to fill or flush the water tank from the outside through the wall of the vehicle, as well as with a flap unit (1) according to any one of the preceding claims, characterised in that the water tank (22) has an overflow (24) [sic] that ventilates and/or drains the overflowing water via a connection (11) provided in the flap unit to connect a used air or drainage pipe and the flap unit (1) possibly has a second connection (11), that on the inside is attached to a supply pipe of a water tank (22) and makes the filling of the water tank (22) from the outside feasible.

15. A water tank system according to claim 14, characterised in that the port region of the overflow on the side of the water tank is so arranged or constructed, that during normal travel, even when the tank is filled to the nominal filling level, essentially no water will be lost via the overflow.

16. A water tank system according to claim 14 or 15, characterised in that a connection (23 or 11) is so constructed that a filler hose, conveying the pressurised water, can be attached to it and, preferably, a valve (25), responding in accordance with the water level, preferably in the form of a float valve, is provided in the water tank (22), so that this valve interrupts the supply connection between the connection (23 and 11) and the water tank (22) against the water pressure as soon as a predetermined water level is reached in the water tank (22).
